(19) United States
(12) Patent Application Publication
(10) Pub. No.: US 2013/0033047 A1
(43) Pub. Date: Feb. 7, 2013

(54) COLLISION ENERGY DISSIPATING BUMPER

(71) Applicants: Lucjan Lagiewka, Kowary (PL); Stanislaw Gumula, Krakow (PL); Adam Jakubiak, Zgorzelec (PL)

(72) Inventors: Lucjan Lagiewka, Kowary (PL); Stanislaw Gumula, Krakow (PL); Adam Jakubiak, Zgorzelec (PL)

(73) Assignee: CENTRUM BADAWCZO ROZWOJOWE EPAR SP. Z O.O, Kowary (PL)

(21) Appl. No.: 13/641,878

(22) PCT Filed: Apr. 20, 2011
(86) PCT No.: PCT/PL2011/050007

§ 371 Date: Oct. 18, 2012

(30) Foreign Application Priority Data
Apr. 21, 2010 (PL) 391032

(51) Int. Cl. B60R 19/20

(52) U.S. Cl. 293/107

(57) ABSTRACT

A bumper has a ram (1) cooperating by a pressure fluid chamber (5) with a collision energy dissipating unit (11), in which kinetic energy of progressive motion is converted into kinetic energy of rotary motion. The pressure fluid chamber (5) is made as an angle fluid splitter (4) comprising an input cylinder (3) co-operating with a piston (2) of the ram (1) and at least two output cylinders (6, 7) angularly deviated from an axis (20) of the input cylinder (3), said output cylinders co-operating with pistons (9), the piston rods (10) of which are linked with the energy dissipating units (11) driving spinning masses (15).

This invention concerns a collision energy dissipating bumper in which kinetic energy of progressive motion is converted into kinetic energy of rotary motion. This solution is to be used especially in motorized vehicles as well as in other objects exposed to unexpected collisions.

From patent application WO2004028864 a device for protecting vehicles against collision effects is known in which kinetic energy suddenly created by a collision is converted into kinetic energy of spinning masses.

According to this known solution vehicles are protected against collision effects by a bumper comprising a toothed bar co-operating with transmissions driving spinning masses. An elastic element is situated between a ram and the toothed bar in order to decrease an impact during an early phase of a collision.

A device for converting kinetic energy is also known from specification WO2005121593, said device comprising a ram co-operating by a pressure fluid chamber with a unit dissipating energy created by a collision. This unit is formed as a rack forcing the rotary motion of spinning masses so as to smoothly change kinetic energy of progressive motion created as a result of the collision into kinetic energy of rotary motion.

The object of this invention is to increase the effectiveness of impact energy dissipation.

A bumper according to the invention comprises a ram co-operating through a pressure fluid chamber with an impact energy dissipating unit, in which kinetic energy of progressive motion is converted into kinetic energy of rotary motion. This solution is characterized in that the pressure fluid chamber is made as an angle fluid splitter comprising an input cylinder co-operating with a piston of the ram and at least two output cylinders directed at an angle from an axis of the input cylinder, the said output cylinders co-operating with pistons whose rods are connected with the energy dissipating units driving spinning masses.

In an advantageous solution axes of the output cylinders are deviated at an angle of 90° in relation to the axis of the input cylinder.

In another advantageous solution the angle fluid splitter comprises three output cylinders, two outermost of which are deviated at an angle of 90° in relation to an axis of the input cylinder, and the middle output cylinder is situated along the axis of the input cylinder.

In a further advantageous solution the angle fluid splitter comprises four output cylinders. Two outermost output cylinders are deviated at an angle of 90° from the axis of the input cylinder, and two longitudinal output cylinders are parallel to the axis of the input cylinder.

In an advantageous solution the energy dissipating unit driving the spinning masses is made as a rack transmission in which a rack drives a spinning mass by means of a transmission increasing the rotational speed.

By using the pressure fluid chamber made as an angle fluid splitter with its input cylinder co-operating with a piston of the ram, and with at least two output cylinders angularly deviated from the axis of the input cylinder, a greater collision energy dissipation is achieved, that means a greater part of a vehicle energy is taken over by the bumper.

A particularly advantageous effect of a mutual elimination of collision forces is achieved when using the angle splitter in which axes of output cylinders are deviated at an angle of 90° in relation to the axis of the input cylinder.

An embodiment of the invention is shown in the drawing in which

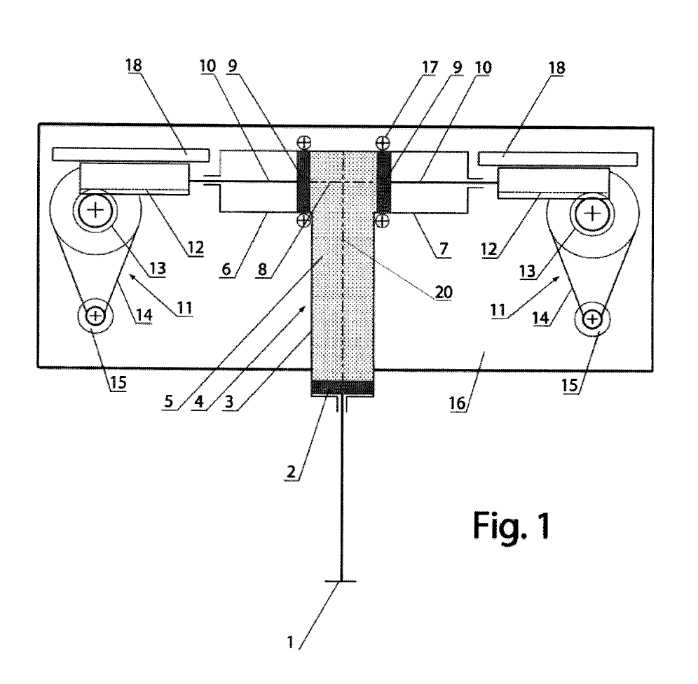

FIG. 1 is an axial section of the bumper having two output cylinders,

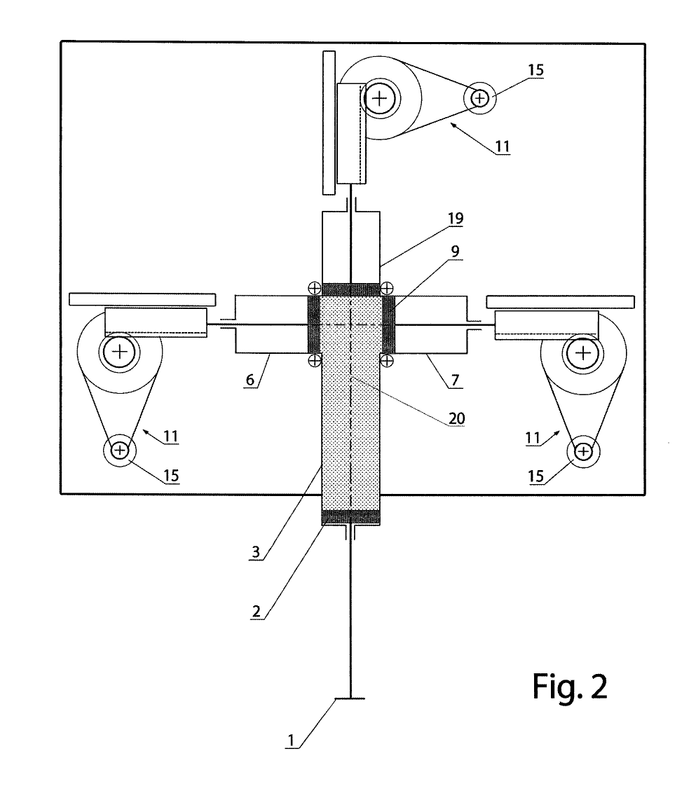

FIG. 2 is an axial section of the bumper having three output cylinders,

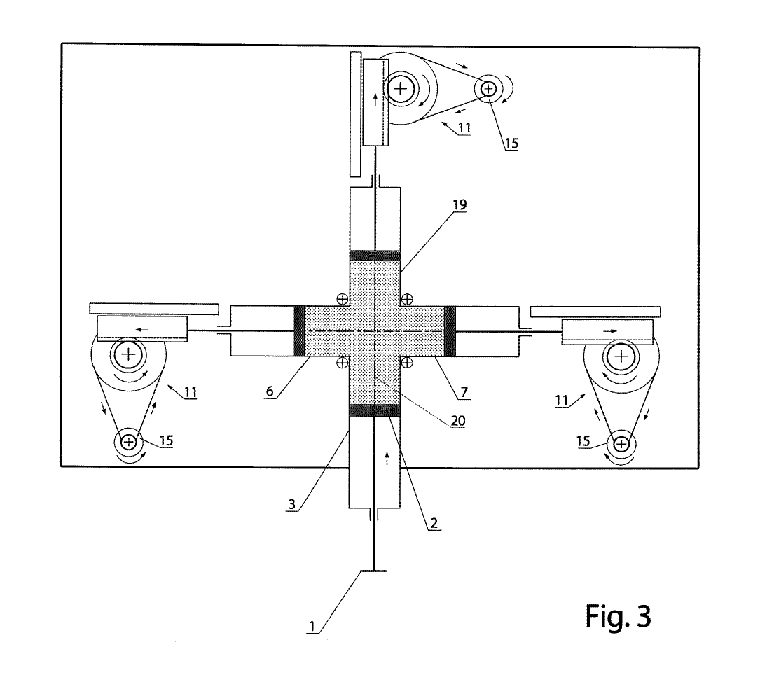

FIG. 3 is an axial section of the bumper having three output cylinders during a collision, and

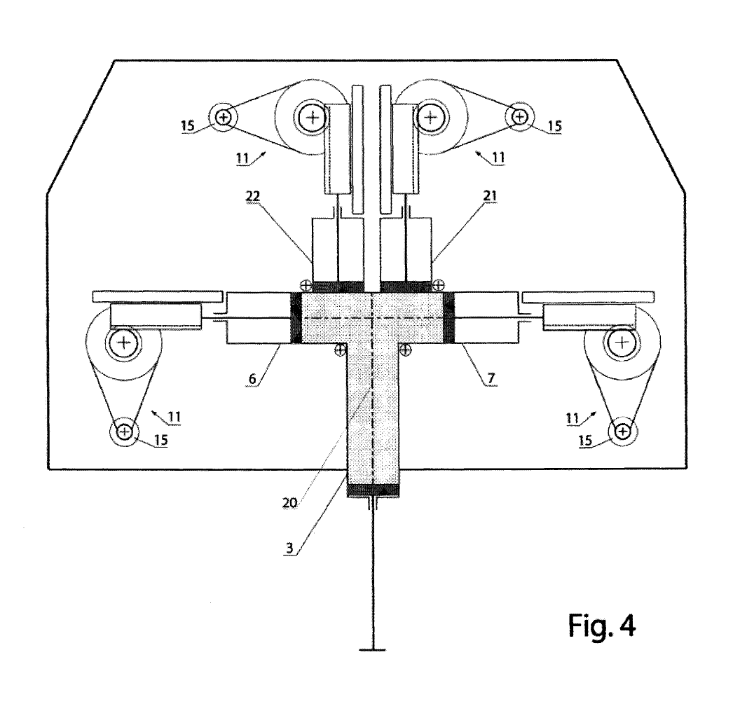

FIG. 4 is an axial section of the bumper having four output cylinders.

In the embodiment illustrated in FIG. 1 a ram 1 is connected with a piston 2 located in an input cylinder 3 of an angle fluid splitter 4 in the form of a three-way pipe creating a pressure fluid chamber 5. The angle fluid splitter 4 has moreover two output cylinders 6, 7 with their axes 8 deviated from an axis of the input cylinder 3 at an angle of 90°. A piston 9 connected to a push rod 10 is located in each of the output cylinders 6, 7, the said push rods 10 of each piston located in the output cylinders 6, 7 are coupled with an energy dissipating unit 11. The energy dissipating unit 11 used in this embodiment during a collision changes kinetic energy of progressive motion into kinetic energy of rotary motion. The energy dissipating unit 11 consists of a rack 12 co-operating with a gear 13 connected with a transmission 14 increasing the rotation speed, the said transmission 14 driving spinning masses 15 having a determined moment of inertia.

Cooperating parts of the bumper are fastened inside the vehicle construction or inside the vehicle bumper in such a way that the ram 1 is located in an area of the greatest risk of a collision, and parts participating in energy taking over are located in an area protected against an excessive deformation. In the embodiment illustrated in FIG. 1 the bumper is fastened on a body plate 16, and bumper parts involved in energy takeover are fastened to said plate in such a way as to provide their proper co-operation during a collision. The angle fluid splitter 4, sliding guides 18 for the racks 12 and axles of the transmissions 14 increasing the rotation speed are fastened to the body plate 16.

FIG. 2 shows a bumper comprising an angle fluid splitter in which the piston 2 of the ram 1 is located in the input cylinder 3, and three output cylinders 6, 7, 19 are arranged in equal angle intervals, whereas axes of two outermost output cylinders 6, 7 are deviated from an axis 20 of the input cylinder 3 at an angle of 90°, and a single middle output cylinder 19 is situated along the axis 20 of the input cylinder 3. While the device is acting, the pistons 9 sliding in the output cylinders 6, 7, 19 are driving the spinning masses 15 in the energy dissipating units 11.

FIG. 3 shows a bumper comprising an angle fluid splitter with three output cylinders 6, 7, 19 while working as a result of a collision. While this device is working, the pistons 9 sliding in the output cylinders 6, 7, 19 drive the spinning masses 15 in the energy dissipating units 11. The arrows near the moving elements show the direction of their shift or rotation.

In another embodiment illustrated in FIG. 4 the angle fluid splitter has four output cylinders 6, 7, 21, 22. The two outermost output cylinders 6, 7 are deviated from the axis 20 of the input cylinder 3 at an angle of 90°, and two longitudinal output cylinders 21, 22 are located on both sides of the axis 20 of the input cylinder 3 parallel to said axis. The spinning masses 15 of each of the said four energy dissipating units 11 are driven in the same way as in embodiments illustrated in FIGS. 1-3.

According to the invention and as it is illustrated in FIG. 1 collision energy received by the ram 1 of the bumper as kinetic energy of progressive motion is transmitted by a fluid shock absorber, made as a pressure fluid chamber 5, to the collision energy dissipating unit 11, in which kinetic energy of progressive motion is converted into kinetic energy of rotation motion by driving the spinning masses 15.

Kinetic energy of progressive motion received by the ram 1 is divided in the pressure fluid chamber 5 of the fluid shock absorber into at least two directions. In the embodiments illustrated in FIG. 1-FIG. 4 collision energy by a thrust of a pressured agent inside the pressure fluid chamber is divided respectively into two, three and four directions. The fluid moving under the pressure is forced into the output cylinders in which moving pistons drive spinning masses. In the embodiments the spinning masses 15 are driven by means of a rack transmission coupled with the transmission 14 increasing the rotation speed.

Each kind of a transmission may be used as the transmission 14 increasing the rotation speed. Especially one may use belt transmissions, chain transmissions as well as all kinds of toothed transmissions.

The strength of parts participating in receiving and transmitting collision energy is selected depending on a mass of a vehicle in which the bumper according to the invention is to be used and depending on a speed reached by that vehicle, thus depending on parameters characteristic for kinetic energy of progressive motion reached by that vehicle. In a case the bumper is used for protecting objects exposed to the impact of outer forces, strength parameters of bumper parts are selected based on the most probable values of energy received by the protected object.

The cushion ability of the fluid splitter 4 is selected depending on the use of the bumper according to the invention. To achieve this aim, an inner space of the fluid splitter 4 closed between its pistons is filled with fluid of suitable compressibility and being under a suitable initial pressure. When using a gas, the maximum protection of mechanical transmissions driving spinning masses against an impact load is achieved, whereas when using a liquid characterized by a low compressibility, an initial load of mechanical transmissions is greater, but at the same time the efficiency of converting kinetic energy of progressive motion into kinetic energy of rotation motion is better. A suitable compromise between minimizing the impact load of parts in mechanical transmissions and obtaining suitable effectiveness of energy conversion is achieved by filling the space inside the fluid splitter 4 with a liquid-gas mixture or with a suitably chosen material undergoing the plastic deformation, for example an elastomer.

In order to obtain the correct bumper activity, the spinning masses 15 after achieving the maximum rotation speed during collision are disengaged from co-operation with driving elements transmitting energy to them.

1. A collision energy dissipating bumper comprising a ram cooperating by a pressure fluid chamber with a collision energy dissipating unit, in which kinetic energy of progressive motion is converted into kinetic energy of rotary motion, characterised in that the pressure fluid chamber is made as an angle fluid splitter comprising an input cylinder cooperating with a piston of the ram and at least two output cylinders angularly deviated from an axis of the input cylinder, the said output cylinders co-operating with pistons, the piston rods of which are linked with the energy dissipating units driving spinning masses.

2. A bumper according to claim 1, characterized in that axes of the output cylinders are deviated at an angle of 90° from the axis of the input cylinder.

3. A bumper according to claim 1, characterised in that the angle fluid splitter comprises three output cylinders, whereas the two outermost output cylinders are deviated at an angle of 90° from the axis of the input cylinder, and the middle output cylinder is located along the axis of the input cylinder.

4. A bumper according to claim 1, characterised in that the angle fluid splitter comprises four output cylinders, whereas the two outermost output cylinders are deviated at an angle of 90° from the axis of the input cylinder, and two longitudinal output cylinders are situated parallel to the axis of the input cylinder.

5. A bumper according to claim 1, characterised in that the energy dissipating unit driving the spinning masses is made as a rack transmission in which a rack drives said spinning mass by means of a transmission increasing its rotation speed.
